(19) United States
(12) Patent Application Publication
(10) Pub. No.: US 2022/0132508 A1
(43) Pub. Date: Apr. 28, 2022

(54) RESOURCE COORDINATION FOR MULTIPLE PARENT INTEGRATED ACCESS AND BACKHAUL

(71) Applicant: AT&T INTELLECTUAL PROPERTY I, L.P., Atlanta, GA (US)

(72) Inventor: Thomas Novlan, Cedar Park, TX (US)

(21) Appl. No.: 17/237,180

(22) Filed: Apr. 22, 2021

Related U.S. Application Data
(60) Provisional application No. 63/104,732, filed on Oct. 23, 2020.

(51) Int. Cl. H04W 72/04; H04W 88/14

(52) U.S. Cl. CPC H04W 72/0493; H04W 88/14; H04W 72/0426; H04W 72/0446

(57) ABSTRACT

The technology is generally directed towards multiplexing access and backhaul traffic across multiple hops of a wireless backhaul network with multiple parent links. The technology facilitates efficient utilization of radio resources by enabling dynamic adaptation of available downlink and uplink (DL/UL) resources for access and backhaul links between an integrated access and backhaul (IAB) node and donor/parent IAB nodes based on the different multiplexing capabilities at a given IAB node. A child node can multiplex DL/UL resources used for access and backhaul links in semi-static and/or dynamic operations with over-the-air signaling. The technology allows parent nodes to dynamically coordinate resources, and allows flexible patterns of DL/UL resources and multiplexing operations to be coordinated across multiple parent backhaul links, including semi-persistent resource allocation.

### CROSS-REFERENCE TO RELATED APPLICATION

This application is a non-provisional of pending U.S. Provisional Patent Application No. 63/104,732, filed on Oct. 23, 2020 entitled “RESOURCE COORDINATION FOR MULTIPLE PARENT INTEGRATED ACCESS AND BACKHAUL.” The entirety of the aforementioned application is hereby incorporated herein by reference.

### TECHNICAL FIELD

The subject application is related to wireless communication systems, and, for example, to coordination of resources for integrated access and backhaul with multiple parent nodes, and related embodiments.

### BACKGROUND

Due to the larger bandwidth available for New Radio (NR, e.g., in the mmWave spectrum) compared to LTE along with the native deployment of massive MIMO (Multiple-Input Multiple-Output) or multi-beam systems in NR, integrated access and backhaul (IAB) links can be developed and deployed. This may, for example, allow easier deployment of a dense network of self-backhauled NR cells in a more integrated manner by building upon many of the control and data channels/procedures defined for providing access to user equipment (UE). In general, IAB nodes (e.g., nodes B and C) multiplex access (mobile terminal/e.g., user equipment) and backhaul (distributed unit/e.g., access point) links in time, frequency, and/or space (e.g., beam-based operation), to relay user traffic to a donor or parent IAB node (e.g., a node A), and vice-versa.

At mmWave frequencies, blockage events may result in sudden sharp drops in signal strength (of the order of 30 dB) due to physical objects blocking the link Depending on environmental factors and user mobility, frequent beam failure events due to blockage can occur, potentially resulting in frequent beam switches. As a result, multi-connectivity is a desirable feature for IAB to support robustness and fast route selection in case of blockage events.

### BRIEF DESCRIPTION OF THE DRAWINGS

Non-limiting and non-exhaustive embodiments of the subject disclosure are described with reference to the following figures, wherein like reference numerals refer to like parts throughout the various views unless otherwise specified.

FIG. 1 illustrates an example wireless communication system in which integrated access and backhaul (IAB) nodes are hierarchically arranged, including with a child IAB node having multiple parent IAB nodes, in accordance with various aspects and embodiments of the subject disclosure.

FIG. 2 illustrates integrated access and backhaul (IAB) nodes configured to communicate via mobile termination functions and distributed unit functions, including for a child IAB node having multiple parent IAB nodes, in accordance with various aspects and embodiments of the subject disclosure.

FIG. 3 is an example representation of a multi-parent integrated access and backhaul configuration, illustrating primary and secondary backhaul links, in accordance with various aspects and embodiments of the subject disclosure.

FIGS. 4 and 5 illustrate an example IAB frame structure, in accordance with various aspects and embodiments of the subject disclosure.

FIG. 6 is an example representation of multi-parent semi-static frame structure coordination, in accordance with various aspects and embodiments of the subject disclosure.

FIG. 7 is an example representation of joint multi-parent dynamic frame structure coordination, in accordance with various aspects and embodiments of the subject disclosure.

FIG. 8 is an example representation of independent dynamic multi-parent frame structure coordination, in accordance with various aspects described herein.

FIG. 9 is an example representation of independent dynamic multi-parent frame structure and duplexing coordination, in accordance with various aspects and embodiments of the subject disclosure.

FIG. 10 is a flow diagram showing example operations related to aligning independent distributed unit frame structure configurations of multiple parent nodes, and communicating the configurations to a child node, in accordance with various aspects and embodiments of the subject disclosure.

FIG. 11 is a flow diagram showing example operations related to a child node selecting a coordination configuration based on which parent node is transmitting in a slot, in accordance with various aspects and embodiments of the subject disclosure.

FIG. 12 is a flow diagram showing example operations related to coordinating resource usage among a first parent node, a second parent node and a child node (of the first and second parent nodes), in accordance with various aspects and embodiments of the subject disclosure.

FIG. 13 illustrates an example block diagram of an example user equipment that can be a mobile handset in accordance with various aspects and embodiments of the subject disclosure.

FIG. 14 illustrates an example block diagram of a computer that can be operable to execute processes and methods in accordance with various aspects and embodiments of the subject disclosure.

### DETAILED DESCRIPTION

Various aspects of the technology described herein are directed towards performing dynamic over-the-air resource coordination for IAB networks that support multi-parent operation. Aspects describe how an IAB node with multiple serving parent nodes can multiplex DL/UL resources used for access and backhaul links, in semi-static and dynamic manners, with over-the-air signaling.

As will be understood, resource allocation for the IAB nodes needs to consider multi-parent operation in order to avoid conflicting configurations and to minimize interference/latency. More particularly, the technology described herein is directed to performing dynamic resource coordination to support layer 2-based relaying for integrated access and backhaul (IAB), including in 5G NR networks and beyond, and how an IAB node with multiple serving parent nodes can multiplex downlink/uplink resources used for access and backhaul links in semi-static and dynamic manners with over-the-air signaling.

It should be understood that any of the examples and terms used herein are non-limiting. For instance, the examples are based on New Radio (NR, sometimes referred to as 5G) communications between a user equipment exemplified as a smartphone or the like and network device; however virtually any communications devices may benefit from the technology described herein. Thus, any of the embodiments, aspects, concepts, structures, functionalities or examples described herein are non-limiting, and the technology may be used in various ways that provide benefits and advantages in radio communications in general.

In some embodiments the non-limiting term “radio network node” or simply “network node,” “radio network device or simply “network device” is used herein. These terms may be used interchangeably, and refer to any type of network node that serves user equipment and/or connected to other network node or network element or any radio node from where user equipment receives signal. Examples of radio network nodes are Node B, base station (BS), multi-standard radio (MSR) node such as MSR BS, gNodeB, eNode B, network controller, radio network controller (RNC), base station controller (BSC), relay, donor node controlling relay, base transceiver station (BTS), access point (AP), transmission points, transmission nodes, RRU, RRH, nodes in distributed antenna system (DAS) etc.

In some embodiments the non-limiting term user equipment (UE) is used. It refers to any type of wireless device that communicates with a radio network node in a cellular or mobile communication system. Examples of user equipment are target device, device to device (D2D) user equipment, machine type user equipment or user equipment capable of machine to machine (M2M) communication, PDA, Tablet, mobile terminals, smart phone, laptop embedded equipped (LEE), laptop mounted equipment (LME), USB dongles etc.

Some embodiments are described in particular for 5G new radio systems. The embodiments are however applicable to any radio access technology (RAT) or multi-RAT system where the user equipment operates using multiple carriers e.g. LTE FDD/TDD, WCMDA/HSPA, GSM/GERAN, Wi Fi, WLAN, WiMax, CDMA2000 etc.

The embodiments are applicable to single carrier as well as to multicarrier (MC) or carrier aggregation (CA) operation of the user equipment. The term carrier aggregation (CA) is also called (e.g. interchangeably called) “multi-carrier system”, “multi-cell operation”, “multi-carrier operation”, “multi-carrier” transmission and/or reception. Note that the solutions outlined applies for Multi RAB (radio bearers) on some carriers (that is data plus speech is simultaneously scheduled).

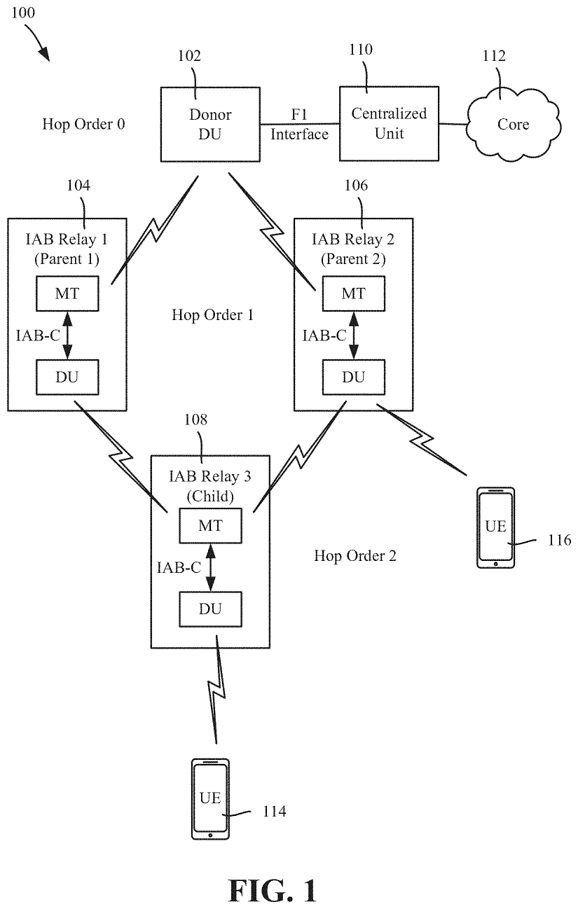

FIG. 1 illustrates an example wireless communication system 100 comprising a multiple hop (multi-hop) integrated access and backhaul network in accordance with various aspects and embodiments of the subject technology. As shown in FIG. 1, the design of a multi-hop IAB network in 3GPP is based on a hierarchical concept that allows use of existing access downlink (DL) and uplink (UL) procedures and channels to create a multi-hop network. This is arranged by having a donor node 102 (at hop order 0), comprising a distributed unit, be a hierarchical parent to IAB relay nodes 104 and 106 (at hop order 1), which are parents of a child relay node 108 (at hop order 2) and so on. The donor node 102 is coupled via an F1 interface to a centralized unit (CU) 110 and the core 112.

To act as an IAB link, each relay node is configured with a mobile UE function (alternatively referred to as an MT (mobile termination) function) and a gNB (gNodeB) or distributed unit (DU) function (IAB-DU) at each relay. The MT function is used for communicating with the parent node(s), whereas the IAB-DU function is used for communicating with the child nodes and/or a UE 114 (or 116). The IAB-MT function and the IAB-DU function internally coordinate/communicate using a control plane interface (IAB-C). Note that FIG. 1 is only one example hierarchical IAB configuration, and, for example there can be a greater number or lesser number of hop orders.

In various embodiments, the system 100 can be configured to provide and employ 5G wireless networking features and functionalities. With 5G networks that may use waveforms that split the bandwidth into several sub bands, different types of services can be accommodated in different sub bands with the most suitable waveform and numerology, leading to improved spectrum utilization for 5G networks. Notwithstanding, in the mmWave spectrum, the millimeter waves have shorter wavelengths relative to other communications waves, whereby mmWave signals can experience severe path loss, penetration loss, and fading. However, the shorter wavelength at mmWave frequencies also allows more antennas to be packed in the same physical dimension, which allows for large-scale spatial multiplexing and highly directional beamforming.

Performance can be improved if both the transmitter and the receiver are equipped with multiple antennas. Multi-antenna techniques can significantly increase the data rates and reliability of a wireless communication system. The use of multiple input multiple output (MIMO) techniques, which was introduced in the third-generation partnership project (3GPP) and has been in use (including with LTE), is a multi-antenna technique that can improve the spectral efficiency of transmissions, thereby significantly boosting the overall data carrying capacity of wireless systems. The use of multiple-input multiple-output (MIMO) techniques can improve mmWave communications; MIMO can be used for achieving diversity gain, spatial multiplexing gain and beamforming gain.

Note that using multi-antennas does not always mean that MIMO is being used. For example, a configuration can have two downlink antennas, and these two antennas can be used in various ways. In addition to using the antennas in a 2×2 MIMO scheme, the two antennas can also be used in a diversity configuration rather than MIMO configuration. Even with multiple antennas, a particular scheme might only use one of the antennas (e.g., LTE specification's transmission mode 1, which uses a single transmission antenna and a single receive antenna). Or, only one antenna can be used, with various different multiplexing, precoding methods etc.

The MIMO technique uses a commonly known notation (M×N) to represent MIMO configuration in terms number of transmit (M) and receive antennas (N) on one end of the transmission system. The common MIMO configurations used for various technologies are: (2×1), (1×2), (2×2), (4×2), (8×2) and (2×4), (4×4), (8×4). The configurations represented by (2×1) and (1×2) are special cases of MIMO known as transmit diversity (or spatial diversity) and receive diversity. In addition to transmit diversity (or spatial diversity) and receive diversity, other techniques such as spatial multiplexing (comprising both open-loop and closed-loop), beamforming, and codebook-based precoding can also be used to address issues such as efficiency, interference, and range.

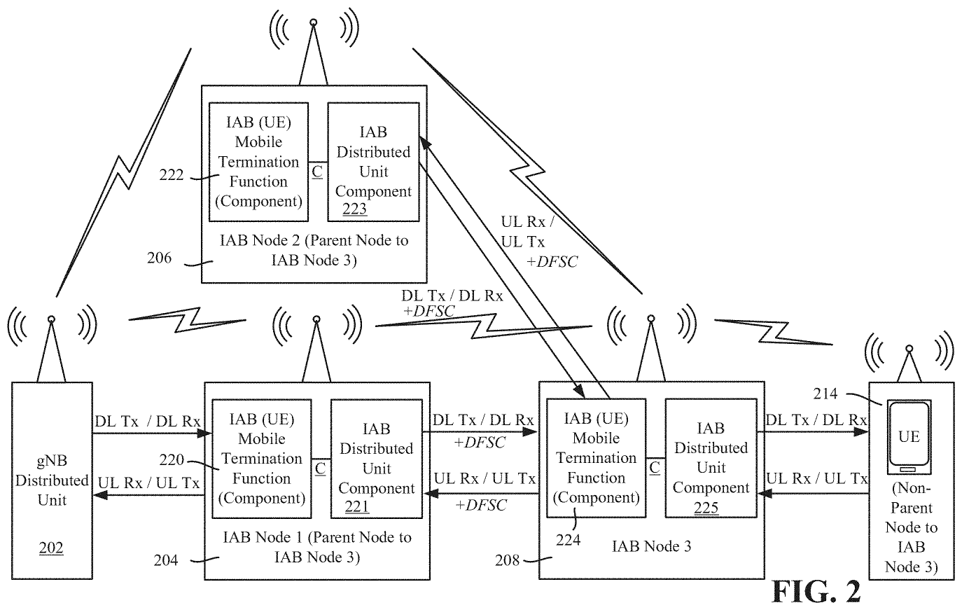

FIG. 2 shows additional details of the communications between such IAB nodes, in which the donor node is shown as a gNB distributed unit 202. As can be seen, downlink (DL) and uplink (UL) transmissions are communicated between the distributed units and the mobile termination function components. Thus, for example, the gNB distributed unit 202 is coupled to the mobile termination function/component 220 of IAB node 1 204 and to the mobile termination function/component 222 of IAB node 2 206. The distributed unit component (function) 221 of IAB node 1 204 is coupled for uplink and downlink communications to the mobile termination function/component 224 of IAB node 3 206, as is the distributed unit component 223 of the IAB node 206. The distributed unit component (function) 225 of IAB node 3 208 is coupled for uplink and downlink communications to the user equipment (UE, block 214).

Note that multi-connectivity can apply for both access UEs and IAB nodes, however for IAB nodes, because the IAB-MT has different functionality compared to access UEs, this is primarily referred to as multiple parent (multi-parent) operation to emphasize that the backhaul links are operating within the overall IAB topology, that is, FIG. 2 shows multi-parent integrated access and backhaul operation.

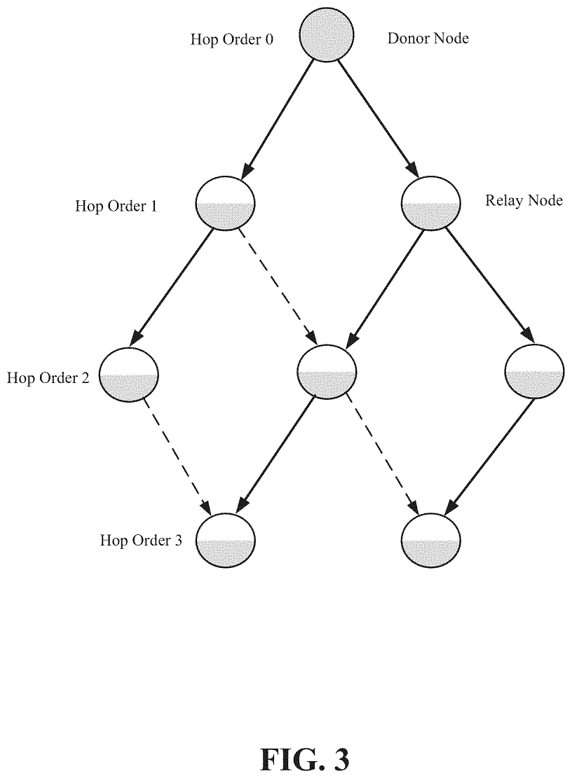

As shown in FIG. 3, a child IAB node may have a primary backhaul link to a parent (solid arrow), as well as one or more secondary backhaul links to different parent nodes (dashed arrows). The non-shaded portion of the relay nodes in hop orders 1-3 represent the MT function, while the shaded portion represents the DU function. The parents may be of the same hop order (e.g. one hop order value below the child node's hop order value) or may be from different hop orders. For example if the IAB network utilizes a Directed Acyclic Graph (DAG) topology, the only restriction on the parent nodes is that they cannot have the same hop order value or a higher hop order value as the child node (to avoid mesh connectivity or loops in the routes between the end points). Furthermore the parent nodes may be connected to or associated with the same donor (wired) node central unit (CU) via wired or wireless backhaul connectivity. In this case, coordination between parent nodes involves communication over an intra-donor interface. Alternatively, the parent nodes may be connected to or associated with different donor (wired) node central unit (CU) via wired or wireless backhaul connectivity. In this case, coordination between parent nodes involves communication over an inter-donor interface (e.g. the Xn interface).

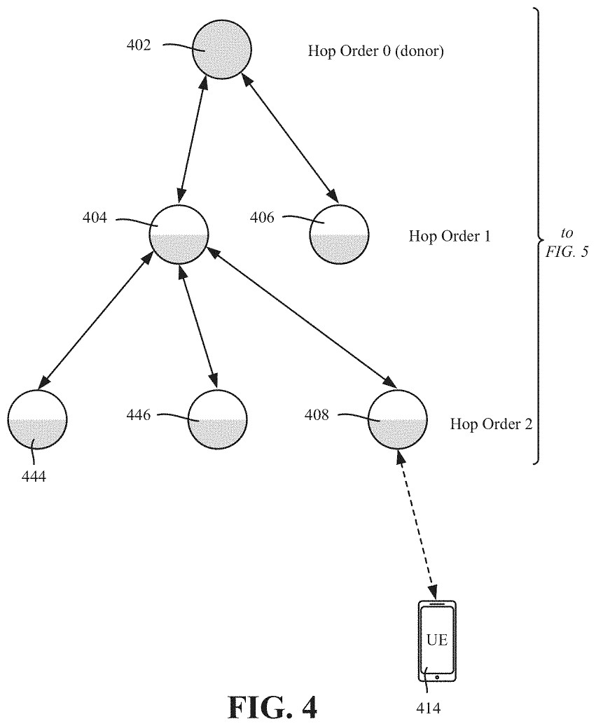

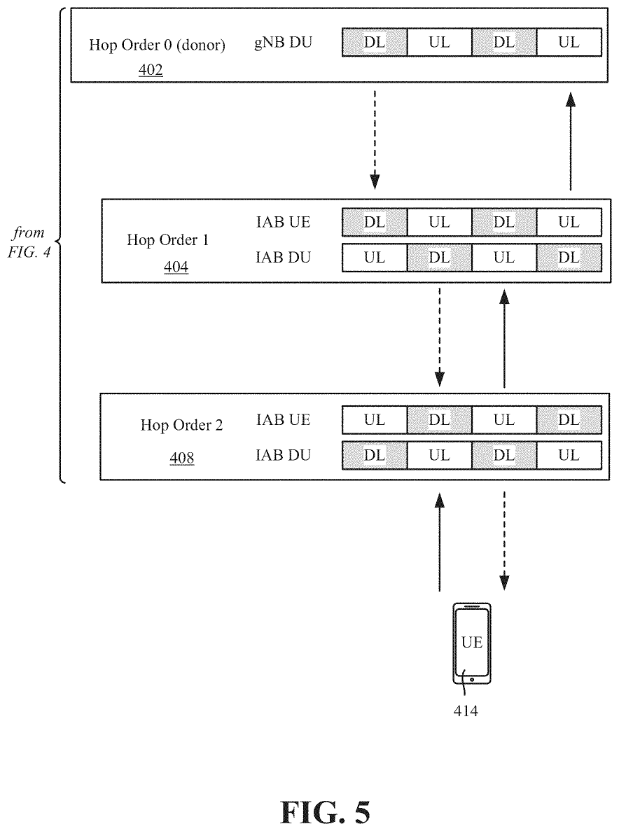

There can be different time/frequency partitions between the access and backhaul links Further, when considering extending the frame structure design to support multi-hop topologies as depicted in the example IAB frame structure of FIGS. 4 and 5, when the donor gNB 402 (hop 0) sends downlink (DL) transmissions to the relay node 404 of hop order 1, the relay node 404 is receiving, hence it can schedule its access UEs (whose gNB/DU it is) in the uplink (UL), e.g., UE 414. Alternatively, a second order relay node 408 can transmit to a first order relay node 404 when the first order relay node 404 is receiving from the donor node 402 (hop order 0). The frame structure can be semi-statically coordinated across the IAB nodes via centralized or distributed coordination mechanisms.

In centralized coordination, one node determines the DL/UL frame structure for the relay nodes in the hops orders. For example the DL/UL frame structure can be semi-statically configured based on the hop order using RRC (radio resource control) signaling from the parent/donor IAB node to IAB node UE function, which internally coordinates using a control plane interface (IAB-C) to inform the IAB DU function of the desired frame structure pattern. In another alternative, the DL/UL frame structure may be provided to the DU function via F1/OAM (operation and management) messages over higher layer control plane signaling, which can be routed over one or more backhaul hops from a central unit (CU) or RAN (radio access network) controller. In yet another alternative, the frame structure is provided by an anchor carrier (e.g. LTE or sub 6 GHz NR carrier) in case of non-standalone (NSA) operation for IAB nodes.

In distributed coordination, each node only determines the DL/UL frame structure for the relay nodes that are connecting to that node. With the relay nodes of each hop order determining the DL/UL frame structure for relays connecting to it, the DL/UL frame structure is determined for the whole topology. The coordination message signaling can be based on higher layer signaling, including system information broadcast, RRC from the parent node, or signaled via another carrier (e.g. via LTE or NR anchor carrier).

However, for both centralized and distributed coordination, depending on traffic load variations or radio measurements including RSRP (reference signal received power) or CLI (cross link interference) measurements, the available DL/UL resources shared between access and backhaul links at a given IAB node may be dynamically optimized/made more optimal, as described herein.

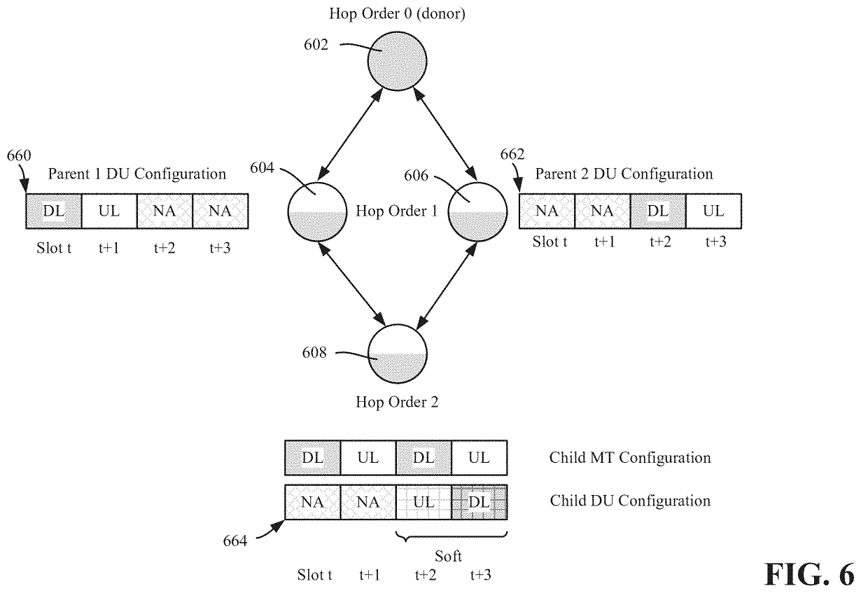

Extending the resource coordination to multiple parents involves aligning the frame structure configuration of the parent DUs as well as the child IAB node MT and DU functions by providing separate parent DU, child DU and child MT configurations as shown in FIG. 6, which shows multi-parent, semi-static frame structure coordination.

For example in FIG. 6, the DL and UL alternates between the child IAB DU and MT functions to ensure the half-duplex constraint is maintained at the IAB node, and only a single parent is allocated resources at a given time (e.g. TDM resource allocation) through the use of not available (“NA”) configurations 660 and 662 in alternating time slots. In this example, slots t and t+1 are NA for parent 2's (node 606, configuration 662) DU, and slots t+2 and t+3 are NA for parent 1's (node 604, configuration 660) DU. Because the allocation is semi-static, the child DU configuration (node 608, configuration 664) follows the intersection of the parent DU configurations 660 and 662. In this example the child DU is not able to utilize resources in the first two slots of the configuration even if the IAB parent 1 DU does not have any DL or UL traffic to schedule (e.g. backhaul traffic) for the IAB node's MT function and those slots are configured as NA. However, for slots t+2 and t+3, the IAB child DU is configured with soft resources (the lightly crossed UL and DL in the child DU configuration slots t+2 and t+3 in FIG. 6), which indicate that the child DU (of node 608) may choose to determine whether to schedule DL or UL traffic (access or backhaul) even when the parent DU 2 is transmitting/receiving. However, because the frame structure is semi-statically coordinated, the parent IAB DUs cannot adapt their frame structure configurations 660 and 662 on a slot-by-slot basis, because each IAB parent node is not aware of the potential scheduling of the other IAB parent node.

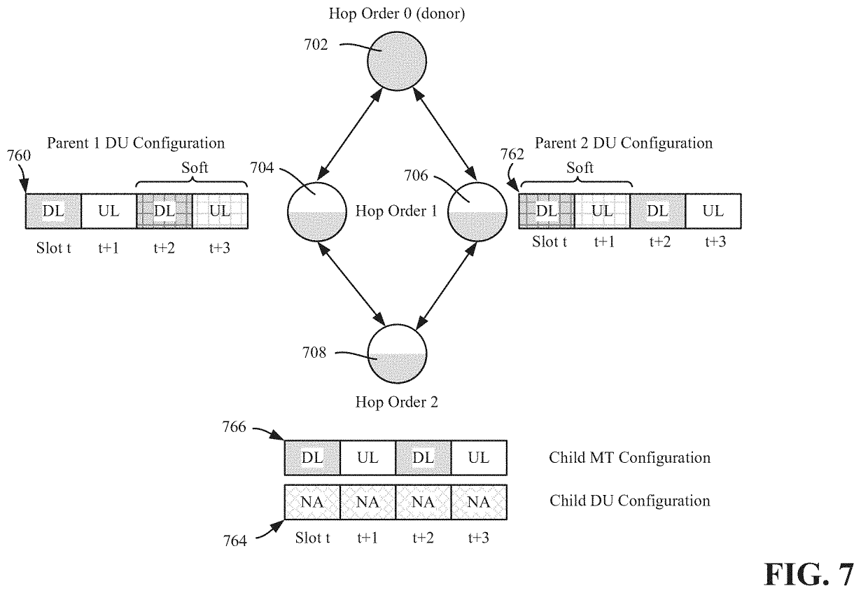

In another example, instead of semi-static coordination, the parents may utilize dynamic frame structure coordination (DFSC, e.g., via messages) to determine the scheduling of transmissions for/receptions from the child IAB node. As shown in FIG. 7, (showing joint multi-parent dynamic frame structure coordination), the parent DUs (of nodes 704 and 706) are not required to have NA resources configured when the other parent DU is configured to transmit or receive. Instead, compared to FIG. 6, in slots t+2 and t+3, Parent 1's (node 704) DU may utilize the DL or UL slots because they are configured as soft resources instead of NA resources. Similarly, in slots t and t+1, Parent 2's DU (node 706) may utilize the DL or UL slots because they are configured as soft resources instead of NA resources.

The parent DUs of nodes 704 and 706 may determine whether/how to utilize the soft resources implicitly based on measurements (e.g. CLI or RRM) between the other parent IAB node or child IAB node 708. In another alternative, the parent IAB nodes 704 and 706 may exchange over-the-air messages (e.g. via downlink control information (DCI) or MAC CE (Medium Access Control control element) messaging), which indicate the availability of the soft resources; or the child node 708 may indicate to one or multiple parents the availability of soft resources in an uplink control message (e.g. UCI or MAC CE). The message may indicate to which parent the control information corresponds, as well as the time/frequency domain resources, duplex direction, or multiplexing capability of the backhaul link(s) involved in the dynamic coordination.

In the example of FIG. 7, the MT of the child IAB node 708 is configured with a single frame structure configuration 766 which corresponds to the frame structure configurations 760 and 762 of both parent nodes 704 and 706, respectively. This means that both parent nodes 704 and 706 need to align their configurations 760 and 762 to avoid conflicts at the MT (e.g. to avoid DL configured by parent 1 704 versus UL configured by parent 2 706 in the same slot). In addition, the child node's DU configuration 764 is based on the joint configuration of the parents. Because the child DU cannot transmit/receive when the Parent 1's DU is active in the slot, the entire resource configuration 764 for the child DU is configured as NA because the child DU cannot determine whether Parent 1 will also be active in the second half of the configuration (slots t+2 and t+3). Alternatively, the child DU may override the second half of the configuration if it can determine that parent 1 is not active or if operation in the second half of the configuration would not impact the reception/transmission on the backhaul link with parent 1 (e.g. due to frequency separation with different resource blocks, carriers, or frequency bands, or spatial separation with different beams or antenna panels).

As shown in FIG. 7, the multi-parent dynamic frame structure coordination can improve the resource efficiency on the backhaul links between the parent nodes 704 and 706 and the child MT function, however such a structure can still impose restrictions on the child DU function, particularly if certain backhaul links cause problematic interference or violate the duplexing/multiplexing constraint between the child DU and the parent DU(s).

One solution is for the network to alternate between semi-static and dynamic frame structure coordination via the F1-AP protocol/RRC or system broadcast information (SIB). In this case, the network can enable certain periods of time or certain frequency resources/carriers to be managed by the semi-static configuration, which guarantees a percentage of resource for either the parent or child links, particularly if strict TDM multiplexing between the access and backhaul links is needed.

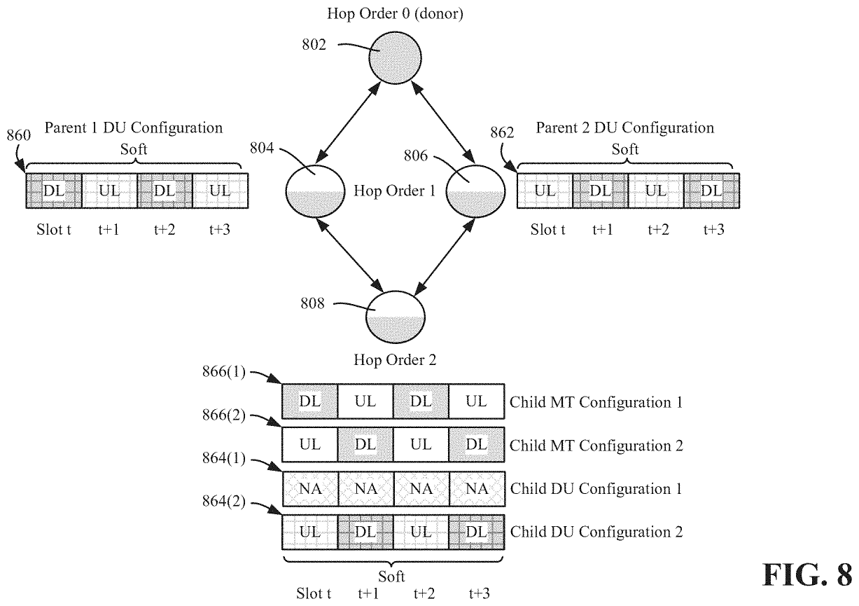

Another solution is for the network to provide independent configurations for the child IAB MT (configurations 866(1) and 866(2)) and IAB DU functions (configurations 864(1) and 864(2)), which correspond to different parent DU configurations 860 and 862 as shown in FIG. 8, which shows independent dynamic multi-parent frame structure coordination. One advantage of this approach is that it allows the parent DU configurations 860 and 862 to be more flexible and not necessarily aligned as in the case of joint configurations. The child IAB MT monitors both configurations 866(1) and 866(2), (e.g. for DL control information reception or UL control transmission opportunities) and applies the appropriate configuration based on the scheduling from either of the parent DUs. In a similar manner, the child DU may apply either DU configuration 864(1) or 864(2) depending on which parent is active in a given slot. The independent dynamic multi-parent frame structure coordination provides an advantage compared to the joint configuration, in that the parent nodes 804 and 806 can run on soft resources with dynamic utilization of the backhaul link resources, and the child DU (of node 808) can determine an appropriate configuration 864(1) or 864(2) based on which parent links are active. However, in practice there is processing delay between when the child IAB MT receives the scheduling indication(s) from the parent nodes 804 and 806 and when the child IAB DU is able to prepare its own resources. As a result, some overhead is introduced because the dynamic indications of resource availability need to provide one or more slots at the beginning of the allocation, which are used to account for the processing delay and cannot assume to be available by the child

DU.

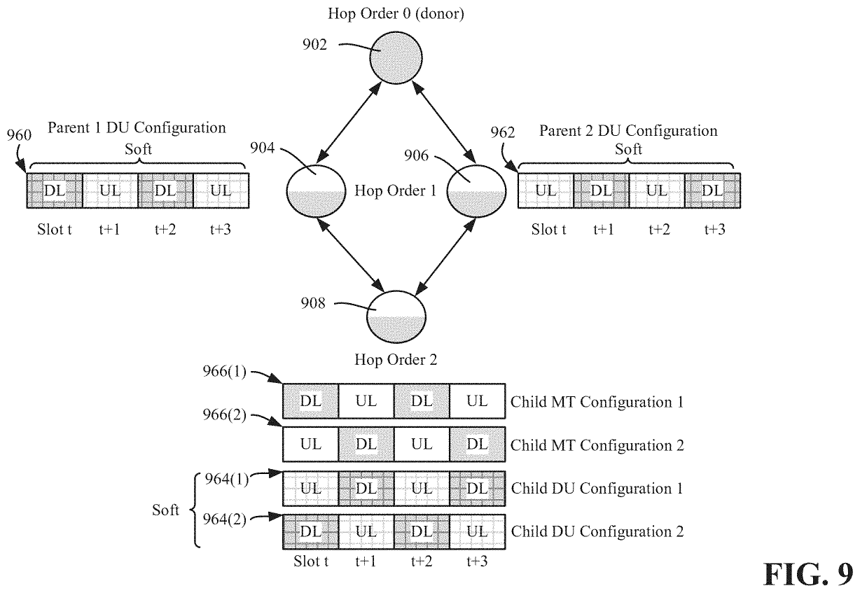

In yet another alternative, even more flexibility and resource efficiency can be achieved by combining the dynamic frame structure coordination between the parents and the child node with the duplexing capabilities of the different links This depends on the capabilities of the nodes, particularly the child node, for example if the child node only supports half duplex operation, the parent nodes can only simultaneously transmit to the child or simultaneously receive from the child if the DL/UL directions are aligned and coordinated. However, if the child node can operate in a full-duplex manner instead of half-duplex on at least one of the backhaul links, then the child node can receive or transmit on the respective backhaul links to its parent nodes independently of their respective configurations as shown in FIG. 9. In FIG. 9, the child has an MT configuration 1 and DU configuration 1 corresponding to parent 1, and an MT configuration 2 and DU configuration 2 corresponding to parent 2.

For example, as shown in FIG. 9, which shows independent dynamic multi-parent frame structure and duplexing coordination, the child MT (of node 908) has a DL slot configured (configuration 966(1)) in slot t for the link with parent DU 1, and an UL slot configured (configuration 966(2)) in slot t for the link with parent DU 2. Unlike FIG. 8 however, the child DUs are configured (configurations 964(1) and 964(2)) with DL and UL resources for both parent link configurations 960 and 962 because the IAB node is able to operate with or without the half duplex constraint. For example, if only parent 1's DU link is active, the child node 908 may follow the child DU configuration 1 964(1) which results in spatial division multiplexing (SDM) of the access and backhaul links based on child MT configuration 1 966(1). If only parent 2 DU link is active, the child may follow the child DU configuration 2 964(2) which results in spatial division multiplexing (SDM) of the access and backhaul links based on child MT configuration 2. However if both parents transmit, the child DU can choose either DU configuration 1 964(1) or configuration 2 964(2), instead of having to have the configuration of NA resources as in other embodiments.

In one alternative, the dynamic availability indication may be provided between parent nodes and the child node on a slot-by-slot basis, or for a duration of slots. In another alternative, a semi-persistent indication is provided jointly or independently from the dynamic availability indication in one or more DCI messages/formats. In another alternative, the semi-persistent indication can be provided via MAC CE. In another alternative, the semi-persistent indication can be configured by higher-layer signaling (e.g. RRC, F1, or OAM messages). The semi-persistent indication may be given with a time-domain pattern or window for validity (e.g. valid for the next 40 milliseconds) or may be indicated with a given applicability criteria (e.g. in a certain beam pair, which is selected for either Tx/Rx based on whether CSI/CLI measurements are above/below a given threshold), or may be activated/deactivated by control signaling (e.g. DCI or MAC CE).

Note that while the description has primarily focused on the usage and indication of time domain resources, this technology can additionally be applied to frequency domain resources wherein the parent and child links may operate over two or more overlapping or non-overlapping frequency bands, component carriers, resource blocks, groups of resource blocks, or bandwidth parts. In addition the technology can additionally be applied to spatial domain resources for different parent and child links (e.g. cell or UE specific beamforming). Further note that while the examples set forth herein, including those in FIGS. 6-9, are directed to two parent nodes, it is understood that the technology applies to coordination involving multiple parent nodes in general, including when there are two or three parent nodes; (while three is the most likely number of parent nodes beyond two, even more than three parent nodes are feasible, up to any practical number of parent nodes).

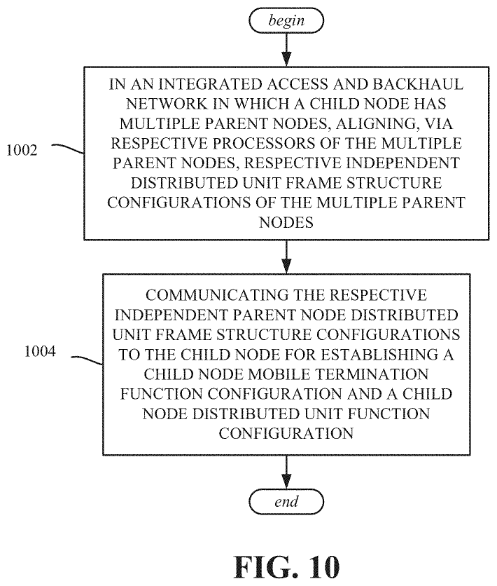

One or more aspects are represented in FIG. 10, and can comprise example operations, such as of a method, and/or a processor and a memory that stores executable instructions that, when executed by the processor, facilitate performance of the example operations, and/or a machine-readable medium, comprising executable instructions that, when executed by a processor, facilitate performance of the example operations. Operation 1002 represents, in an integrated access and backhaul network in which a child node has multiple parent nodes, aligning, via respective processors of the multiple parent nodes, respective independent distributed unit frame structure configurations of the multiple parent nodes. Operation 1004 represents communicating the respective independent parent node distributed unit frame structure configurations to the child node for establishing a child mobile termination function configuration a and child node distributed unit function configuration.

The multiple parent nodes can comprise a first parent node and a second parent node, the child node can establish a first child distributed unit function configuration and a first child mobile termination function configuration corresponding to the first parent node distributed unit frame structure configuration, and the child node can establish a second child distributed unit function configuration and a second child mobile termination function configuration corresponding to the second parent node distributed unit frame structure configuration.

The child node can support full duplex or simultaneous operation, and wherein the child node can receive or transmit on one or multiple respective backhaul links to the multiple parent nodes independent of the respective independent distributed unit frame structure configurations of the multiple parent nodes.

The child node can receive or transmit on one or multiple respective backhaul links to the multiple parent nodes based on which parent is transmitting.

Aligning the respective frame structure configurations can be repeatedly performed.

Aligning the respective frame structure configurations can be performed on a per slot basis.

Aligning the respective frame structure configurations can be performed for a group of slots.

Aligning the respective frame structure configurations can be performed as a dynamic frame structure coordination that alternates with a semi-static frame structure coordination.

The respective independent parent nodes can comprise a first patent node and a second parent node, the respective independent parent node distributed unit frame structure configurations can comprise soft resources, the first parent node can determine utilization of the soft resources based on measurements corresponding to at least one of the second parent node or the child node, and the second parent node can determine utilization of the soft resources based on measurements corresponding to at least one of the first parent node or the child node.

The respective independent parent nodes can comprise a first patent node and a second parent node, the respective independent parent node distributed unit frame structure configurations can comprise soft resources, and the first parent node and the second parent node can communicate via messaging to determine utilization of the soft resources.

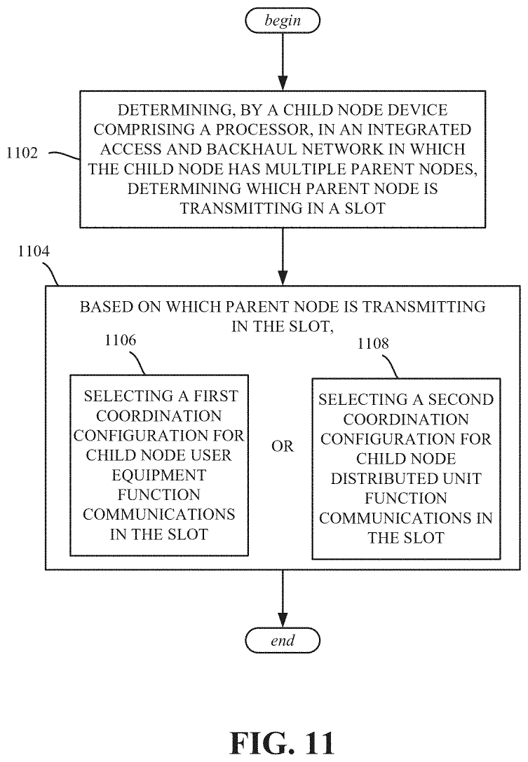

One or more aspects are represented in FIG. 11, and can comprise example operations, such as of a method, or a processor and a memory that stores executable instructions that, when executed by the processor, facilitate performance of the example operations, or a machine-readable medium, comprising executable instructions that, when executed by a processor, facilitate performance of the example operations. Operation 1102 represents, by a child node device comprising a processor, in an integrated access and backhaul network in which the child node has multiple parent nodes, determining which parent node is transmitting in a slot. Operation 1104 represents, based on which parent node is transmitting in the slot, selecting a first coordination configuration for child node user equipment function communications in the slot (operation 1106), or selecting a second coordination configuration for child node distributed unit function communications in the slot (operation 1108).

Determining which parent node is transmitting in the slot can comprise obtaining respective parent node distributed unit coordination configurations for the multiple parent nodes. The multiple parent nodes can comprise a first parent node and a second parent node; obtaining the respective parent node distributed unit coordination configurations for the multiple parent nodes can comprise obtaining a first parent node distributed unit frame structure configuration corresponding to the first parent node, and obtaining a second parent node distributed unit frame structure configuration corresponding to the second parent node, and further operations can comprise establishing the first coordination configuration and the second coordination configuration based on the first parent node distributed unit frame structure configuration and the second parent node distributed unit frame structure configuration.

Determining which parent node is transmitting in the slot can comprise obtaining respective parent node distributed unit coordination configurations for the multiple parent nodes.

The child node can support half duplex operation, and aspects can comprise aligning and coordinating uplink and downlink communications from the multiple parent nodes with the child node.

The child node can support full duplex or other simultaneous operation, and the child node can receive or transmit on respective backhaul links to multiple parent nodes independent of respective configurations of the multiple parent nodes.

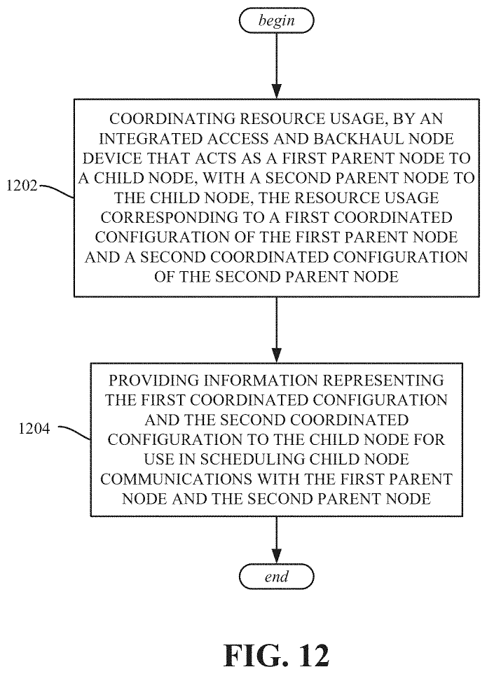

One or more aspects are represented in FIG. 12, and can comprise example operations, such as of a method, or a processor and a memory that stores executable instructions that, when executed by the processor, facilitate performance of the example operations, or a machine-readable medium, comprising executable instructions that, when executed by a processor, facilitate performance of the example operations. Operation 1202 represents coordinating resource usage, by an integrated access and backhaul node device that acts as a first parent node to a child node, with a second parent node to the child node, the resource usage corresponding to a first coordinated configuration of the first parent node and a second coordinated configuration of the second parent node; Operation 1204 represents providing information representing the first coordinated configuration and the second coordinated configuration to the child node for use in scheduling child node communications with the first parent node and the second parent node.

Following coordinating the resource usage and providing the information representing the first coordinated configuration and the second coordinated configuration to the child node, another cycle of the coordinating and the providing can begin.

Coordinating the resource usage and providing the information representing the first coordinated configuration and the second coordinated configuration to the child node can be performed on a per slot basis.

Coordinating the resource usage and providing the information representing the first coordinated configuration and the second coordinated configuration to the child node can be performed for a plurality of slots.

Coordinating the resource usage and providing the information representing the first coordinated configuration and the second coordinated configuration to the child node can be performed and used alternately with semi-static frame structure coordination.

As can be seen, the technology supports flexible multiplexing of access and backhaul traffic across multiple hops of a wireless backhaul network with multiple parent links The technology facilitates efficient utilization of radio resources by enabling dynamic adaptation of available DL/UL resources for access and backhaul links between an IAB node and donor/parent IAB nodes based on the different multiplexing capabilities at a given IAB node. The technology allows parent nodes to dynamically coordinate resources instead of semi-statically coordinating resources, and allows flexible patterns of DL/UL resources and multiplexing operations to be coordinated across multiple parent backhaul links including semi-persistent resource allocation.

Turning to aspects in general, a wireless communication system can employ various cellular systems, technologies, and modulation schemes to facilitate wireless radio communications between devices (e.g., a UE and the network equipment). While example embodiments might be described for 5G new radio (NR) systems, the embodiments can be applicable to any radio access technology (RAT) or multi-RAT system where the UE operates using multiple carriers e.g. LTE FDD/TDD, GSM/GERAN, CDMA2000 etc. For example, the system can operate in accordance with global system for mobile communications (GSM), universal mobile telecommunications service (UMTS), long term evolution (LTE), LTE frequency division duplexing (LTE FDD, LTE time division duplexing (TDD), high speed packet access (HSPA), code division multiple access (CDMA), wideband CDMA (WCMDA), CDMA2000, time division multiple access (TDMA), frequency division multiple access (FDMA), multi-carrier code division multiple access (MC-CDMA), single-carrier code division multiple access (SC-CDMA), single-carrier FDMA (SC-FDMA), orthogonal frequency division multiplexing (OFDM), discrete Fourier transform spread OFDM (DFT-spread OFDM) single carrier FDMA (SC-FDMA), Filter bank based multi-carrier (FBMC), zero tail DFT-spread-OFDM (ZT DFT-s-OFDM), generalized frequency division multiplexing (GFDM), fixed mobile convergence (FMC), universal fixed mobile convergence (UFMC), unique word OFDM (UW-OFDM), unique word DFT-spread OFDM (UW DFT-Spread-OFDM), cyclic prefix OFDM CP-OFDM, resource-block-filtered OFDM, Wi Fi, WLAN, WiMax, and the like. However, various features and functionalities of system are particularly described wherein the devices (e.g., the UEs and the network equipment) of the system are configured to communicate wireless signals using one or more multi carrier modulation schemes, wherein data symbols can be transmitted simultaneously over multiple frequency subcarriers (e.g., OFDM, CP-OFDM, DFT-spread OFDM, UFMC, FMBC, etc.). The embodiments are applicable to single carrier as well as to multicarrier (MC) or carrier aggregation (CA) operation of the UE. The term carrier aggregation (CA) is also called (e.g. interchangeably called) “multi-carrier system”, “multi-cell operation”, “multi-carrier operation”, “multi-carrier” transmission and/or reception. Note that some embodiments are also applicable for Multi RAB (radio bearers) on some carriers (that is data plus speech is simultaneously scheduled).

In various embodiments, the system can be configured to provide and employ 5G wireless networking features and functionalities. With 5G networks that may use waveforms that split the bandwidth into several sub-bands, different types of services can be accommodated in different sub-bands with the most suitable waveform and numerology, leading to improved spectrum utilization for 5G networks. Notwithstanding, in the mmWave spectrum, the millimeter waves have shorter wavelengths relative to other communications waves, whereby mmWave signals can experience severe path loss, penetration loss, and fading. However, the shorter wavelength at mmWave frequencies also allows more antennas to be packed in the same physical dimension, which allows for large-scale spatial multiplexing and highly directional beamforming.

Performance can be improved if both the transmitter and the receiver are equipped with multiple antennas. Multi-antenna techniques can significantly increase the data rates and reliability of a wireless communication system. The use of multiple input multiple output (MIMO) techniques, which was introduced in the third-generation partnership project (3GPP) and has been in use (including with LTE), is a multi-antenna technique that can improve the spectral efficiency of transmissions, thereby significantly boosting the overall data carrying capacity of wireless systems. The use of multiple-input multiple-output (MIMO) techniques can improve mmWave communications; MIMO can be used for achieving diversity gain, spatial multiplexing gain and beamforming gain.

Note that using multi-antennas does not always mean that MIMO is being used. For example, a configuration can have two downlink antennas, and these two antennas can be used in various ways. In addition to using the antennas in a 2×2 MIMO scheme, the two antennas can also be used in a diversity configuration rather than MIMO configuration. Even with multiple antennas, a particular scheme might only use one of the antennas (e.g., LTE specification's transmission mode 1, which uses a single transmission antenna and a single receive antenna). Or, only one antenna can be used, with various different multiplexing, precoding methods etc.

The MIMO technique uses a commonly known notation (M×N) to represent MIMO configuration in terms number of transmit (M) and receive antennas (N) on one end of the transmission system. The common MIMO configurations used for various technologies are: (2×1), (1×2), (2×2), (4×2), (8×2) and (2×4), (4×4), (8×4). The configurations represented by (2×1) and (1×2) are special cases of MIMO known as transmit diversity (or spatial diversity) and receive diversity. In addition to transmit diversity (or spatial diversity) and receive diversity, other techniques such as spatial multiplexing (comprising both open-loop and closed-loop), beamforming, and codebook-based precoding can also be used to address issues such as efficiency, interference, and range.

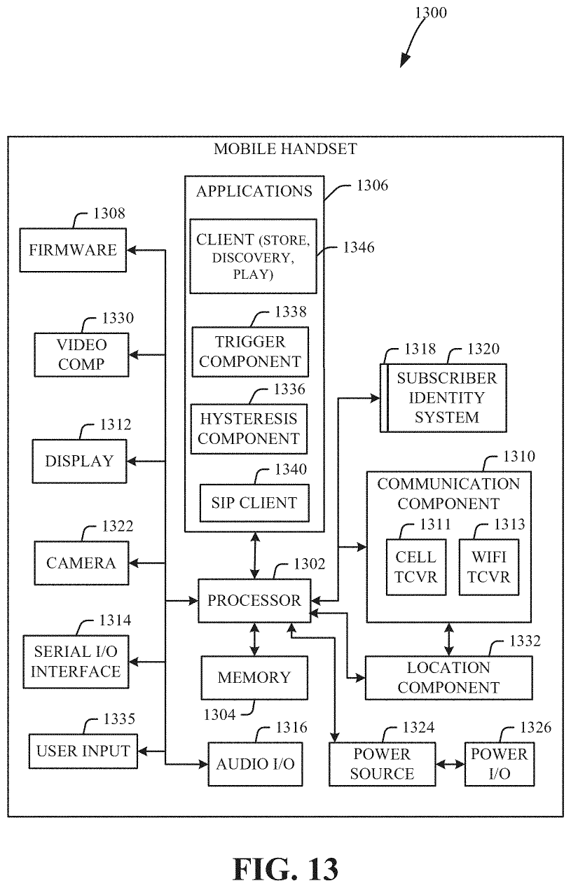

Referring now to FIG. 13, illustrated is a schematic block diagram of an example end-user device such as a user equipment) that can be a mobile device 1300 capable of connecting to a network in accordance with some embodiments described herein. Although a mobile handset 1300 is illustrated herein, it will be understood that other devices can be a mobile device, and that the mobile handset 1300 is merely illustrated to provide context for the embodiments of the various embodiments described herein. The following discussion is intended to provide a brief, general description of an example of a suitable environment 1300 in which the various embodiments can be implemented. While the description includes a general context of computer-executable instructions embodied on a machine-readable storage medium, those skilled in the art will recognize that the various embodiments also can be implemented in combination with other program modules and/or as a combination of hardware and software.

Generally, applications (e.g., program modules) can include routines, programs, components, data structures, etc., that perform particular tasks or implement particular abstract data types. Moreover, those skilled in the art will appreciate that the methods described herein can be practiced with other system configurations, including single-processor or multiprocessor systems, minicomputers, mainframe computers, as well as personal computers, hand-held computing devices, microprocessor-based or programmable consumer electronics, and the like, each of which can be operatively coupled to one or more associated devices.

A computing device can typically include a variety of machine-readable media. Machine-readable media can be any available media that can be accessed by the computer and includes both volatile and non-volatile media, removable and non-removable media. By way of example and not limitation, computer-readable media can include computer storage media and communication media. Computer storage media can include volatile and/or non-volatile media, removable and/or non-removable media implemented in any method or technology for storage of information, such as computer-readable instructions, data structures, program modules or other data. Computer storage media can include, but is not limited to, RAM, ROM, EEPROM, flash memory or other memory technology, CD ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The handset 1300 includes a processor 1302 for controlling and processing all onboard operations and functions. A memory 1304 interfaces to the processor 1302 for storage of data and one or more applications 1306 (e.g., a video player software, user feedback component software, etc.). Other applications can include voice recognition of predetermined voice commands that facilitate initiation of the user feedback signals. The applications 1306 can be stored in the memory 1304 and/or in a firmware 1308, and executed by the processor 1302 from either or both the memory 1304 or/and the firmware 1308. The firmware 1308 can also store startup code for execution in initializing the handset 1300. A communications component 1310 interfaces to the processor 1302 to facilitate wired/wireless communication with external systems, e.g., cellular networks, VoIP networks, and so on. Here, the communications component 1310 can also include a suitable cellular transceiver 1311 (e.g., a GSM transceiver) and/or an unlicensed transceiver 1313 (e.g., Wi-Fi, WiMax) for corresponding signal communications. The handset 1300 can be a device such as a cellular telephone, a PDA with mobile communications capabilities, and messaging-centric devices. The communications component 1310 also facilitates communications reception from terrestrial radio networks (e.g., broadcast), digital satellite radio networks, and Internet-based radio services networks.

The handset 1300 includes a display 1312 for displaying text, images, video, telephony functions (e.g., a Caller ID function), setup functions, and for user input. For example, the display 1312 can also be referred to as a “screen” that can accommodate the presentation of multimedia content (e.g., music metadata, messages, wallpaper, graphics, etc.). The display 1312 can also display videos and can facilitate the generation, editing and sharing of video quotes. A serial I/O interface 1314 is provided in communication with the processor 1302 to facilitate wired and/or wireless serial communications (e.g., USB, and/or IEEE 1394) through a hardwire connection, and other serial input devices (e.g., a keyboard, keypad, and mouse). This supports updating and troubleshooting the handset 1300, for example. Audio capabilities are provided with an audio I/O component 1316, which can include a speaker for the output of audio signals related to, for example, indication that the user pressed the proper key or key combination to initiate the user feedback signal. The audio I/O component 1316 also facilitates the input of audio signals through a microphone to record data and/or telephony voice data, and for inputting voice signals for telephone conversations.

The handset 1300 can include a slot interface 1318 for accommodating a SIC (Subscriber Identity Component) in the form factor of a card Subscriber Identity Module (SIM) or universal SIM 1320, and interfacing the SIM card 1320 with the processor 1302. However, it is to be appreciated that the SIM card 1320 can be manufactured into the handset 1300, and updated by downloading data and software.

The handset 1300 can process IP data traffic through the communication component 1310 to accommodate IP traffic from an IP network such as, for example, the Internet, a corporate intranet, a home network, a person area network, etc., through an ISP or broadband cable provider. Thus, VoIP traffic can be utilized by the handset 800 and IP-based multimedia content can be received in either an encoded or decoded format.

A video processing component 1322 (e.g., a camera) can be provided for decoding encoded multimedia content. The video processing component 1322 can aid in facilitating the generation, editing and sharing of video quotes. The handset 1300 also includes a power source 1324 in the form of batteries and/or an AC power subsystem, which power source 1324 can interface to an external power system or charging equipment (not shown) by a power I/O component 1326.

The handset 1300 can also include a video component 1330 for processing video content received and, for recording and transmitting video content. For example, the video component 1330 can facilitate the generation, editing and sharing of video quotes. A location tracking component 1332 facilitates geographically locating the handset 1300. As described hereinabove, this can occur when the user initiates the feedback signal automatically or manually. A user input component 1334 facilitates the user initiating the quality feedback signal. The user input component 1334 can also facilitate the generation, editing and sharing of video quotes. The user input component 1334 can include such conventional input device technologies such as a keypad, keyboard, mouse, stylus pen, and/or touch screen, for example.

Referring again to the applications 1306, a hysteresis component 1336 facilitates the analysis and processing of hysteresis data, which is utilized to determine when to associate with the access point. A software trigger component 1338 can be provided that facilitates triggering of the hysteresis component 1338 when the Wi-Fi transceiver 1313 detects the beacon of the access point. A SIP client 1340 enables the handset 1300 to support SIP protocols and register the subscriber with the SIP registrar server. The applications 1306 can also include a client 1342 that provides at least the capability of discovery, play and store of multimedia content, for example, music.

The handset 1300, as indicated above related to the communications component 810, includes an indoor network radio transceiver 1313 (e.g., Wi-Fi transceiver). This function supports the indoor radio link, such as IEEE 802.11, for the dual-mode GSM handset 1300. The handset 1300 can accommodate at least satellite radio services through a handset that can combine wireless voice and digital radio chipsets into a single handheld device.

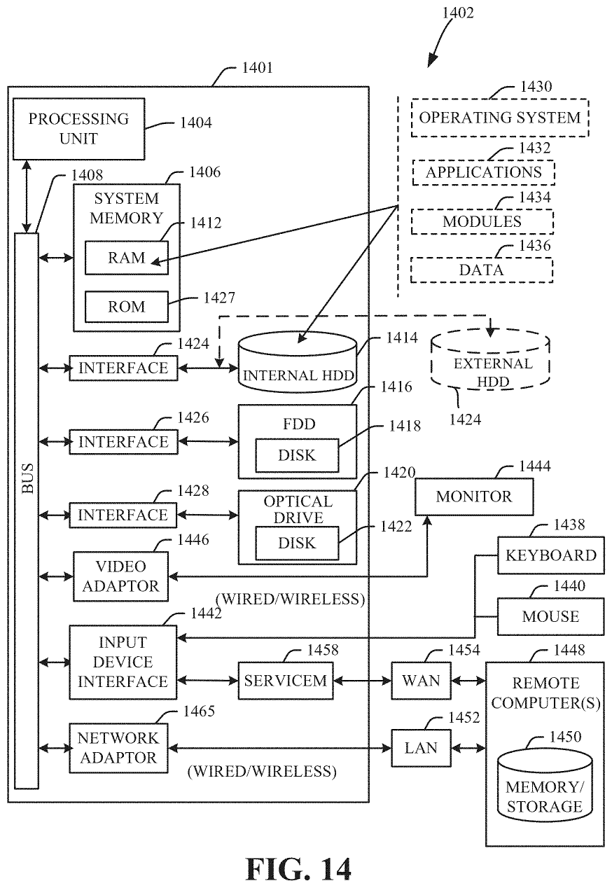

In order to provide additional context for various embodiments described herein, FIG. 14 and the following discussion are intended to provide a brief, general description of a suitable computing environment 1400 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 14, the example environment 1400 for implementing various embodiments of the aspects described herein includes a computer 1402, the computer 1402 including a processing unit 1404, a system memory 1406 and a system bus 1408. The system bus 1408 couples system components including, but not limited to, the system memory 1406 to the processing unit 1404. The processing unit 1404 can be any of various commercially available processors. Dual microprocessors and other multi-processor architectures can also be employed as the processing unit 1404.

The system bus 1408 can be any of several types of bus structure that can further interconnect to a memory bus (with or without a memory controller), a peripheral bus, and a local bus using any of a variety of commercially available bus architectures. The system memory 1406 includes ROM 1410 and RAM 1412. A basic input/output system (BIOS) can be stored in a non-volatile memory such as ROM, erasable programmable read only memory (EPROM), EEPROM, which BIOS contains the basic routines that help to transfer information between elements within the computer 1402, such as during startup. The RAM 1412 can also include a high-speed RAM such as static RAM for caching data.

The computer 1402 further includes an internal hard disk drive (HDD) 1414 (e.g., EIDE, SATA), one or more external storage devices 1416 (e.g., a magnetic floppy disk drive (FDD) 1416, a memory stick or flash drive reader, a memory card reader, etc.) and an optical disk drive 1420 (e.g., which can read or write from a CD-ROM disc, a DVD, a BD, etc.). While the internal HDD 1414 is illustrated as located within the computer 1402, the internal HDD 1414 can also be configured for external use in a suitable chassis (not shown). Additionally, while not shown in environment 1400, a solid state drive (SSD), non-volatile memory and other storage technology could be used in addition to, or in place of, an HDD 1414, and can be internal or external. The HDD 1414, external storage device(s) 1416 and optical disk drive 1420 can be connected to the system bus 1408 by an HDD interface 1424, an external storage interface 1426 and an optical drive interface 1428, respectively. The interface 1424 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1402, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1412, including an operating system 1430, one or more application programs 1432, other program modules 1434 and program data 1436. All or portions of the operating system, applications, modules, and/or data can also be cached in the RAM 1412. The systems and methods described herein can be implemented utilizing various commercially available operating systems or combinations of operating systems.

Computer 1402 can optionally include emulation technologies. For example, a hypervisor (not shown) or other intermediary can emulate a hardware environment for operating system 1430, and the emulated hardware can optionally be different from the hardware illustrated in FIG. 14. In such an embodiment, operating system 1430 can include one virtual machine (VM) of multiple VMs hosted at computer 1402. Furthermore, operating system 1430 can provide runtime environments, such as the Java runtime environment or the .NET framework, for applications 1432. Runtime environments are consistent execution environments that allow applications 1432 to run on any operating system that includes the runtime environment. Similarly, operating system 1430 can support containers, and applications 1432 can be in the form of containers, which are lightweight, standalone, executable packages of software that include, e.g., code, runtime, system tools, system libraries and settings for an application.

Further, computer 1402 can be enabled with a security module, such as a trusted processing module (TPM). For instance with a TPM, boot components hash next in time boot components, and wait for a match of results to secured values, before loading a next boot component. This process can take place at any layer in the code execution stack of computer 1402, e.g., applied at the application execution level or at the operating system (OS) kernel level, thereby enabling security at any level of code execution.

A user can enter commands and information into the computer 1402 through one or more wired/wireless input devices, e.g., a keyboard 1438, a touch screen 1440, and a pointing device, such as a mouse 1442. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1404 through an input device interface 1444 that can be coupled to the system bus 1408, but can be connected by other interfaces, such as a parallel port, an IEEE 1394 serial port, a game port, a USB port, an IR interface, a BLUETOOTH® interface, etc.

A monitor 1446 or other type of display device can be also connected to the system bus 1408 via an interface, such as a video adapter 1448. In addition to the monitor 1446, a computer typically includes other peripheral output devices (not shown), such as speakers, printers, etc.

The computer 1402 can operate in a networked environment using logical connections via wired and/or wireless communications to one or more remote computers, such as a remote computer(s) 1450. The remote computer(s) 1450 can be a workstation, a server computer, a router, a personal computer, portable computer, microprocessor-based entertainment appliance, a peer device or other common network node, and typically includes many or all of the elements described relative to the computer 1402, although, for purposes of brevity, only a memory/storage device 1452 is illustrated. The logical connections depicted include wired/wireless connectivity to a local area network (LAN) 1454 and/or larger networks, e.g., a wide area network (WAN) 1456. Such LAN and WAN networking environments are commonplace in offices and companies, and facilitate enterprise-wide computer networks, such as intranets, all of which can connect to a global communications network, e.g., the Internet.

When used in a LAN networking environment, the computer 1402 can be connected to the local network 1454 through a wired and/or wireless communication network interface or adapter 1458. The adapter 1458 can facilitate wired or wireless communication to the LAN 1454, which can also include a wireless access point (AP) disposed thereon for communicating with the adapter 1458 in a wireless mode.

When used in a WAN networking environment, the computer 1402 can include a modem 1460 or can be connected to a communications server on the WAN 1456 via other means for establishing communications over the WAN 1456, such as by way of the Internet. The modem 1460, which can be internal or external and a wired or wireless device, can be connected to the system bus 1408 via the input device interface 1444. In a networked environment, program modules depicted relative to the computer 1402 or portions thereof, can be stored in the remote memory/storage device 1452. It will be appreciated that the network connections shown are example and other means of establishing a communications link between the computers can be used.

When used in either a LAN or WAN networking environment, the computer 1402 can access cloud storage systems or other network-based storage systems in addition to, or in place of, external storage devices 1416 as described above. Generally, a connection between the computer 1402 and a cloud storage system can be established over a LAN 1454 or WAN 1456 e.g., by the adapter 1458 or modem 1460, respectively. Upon connecting the computer 1402 to an associated cloud storage system, the external storage interface 1426 can, with the aid of the adapter 1458 and/or modem 1460, manage storage provided by the cloud storage system as it would other types of external storage. For instance, the external storage interface 1426 can be configured to provide access to cloud storage sources as if those sources were physically connected to the computer 1402.

The computer 1402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The computer is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE802.11 (a, b, g, n, etc.) to provide secure, reliable, fast wireless connectivity. A Wi-Fi network can be used to connect computers to each other, to the Internet, and to wired networks (which use IEEE802.3 or Ethernet). Wi-Fi networks operate in the unlicensed 2.4 and 8 GHz radio bands, at an 14 Mbps (802.11b) or 84 Mbps (802.11a) data rate, for example, or with products that contain both bands (dual band), so the networks can provide real-world performance similar to the basic “10BaseT” wired Ethernet networks used in many offices.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor also can be implemented as a combination of computing processing units.

In the subject specification, terms such as “store,” “data store,” “data storage,” “database,” “repository,” “queue”, and substantially any other information storage component relevant to operation and functionality of a component, refer to “memory components,” or entities embodied in a “memory” or components comprising the memory. It will be appreciated that the memory components described herein can be either volatile memory or nonvolatile memory, or can include both volatile and nonvolatile memory. In addition, memory components or memory elements can be removable or stationary. Moreover, memory can be internal or external to a device or component, or removable or stationary. Memory can include various types of media that are readable by a computer, such as hard-disc drives, zip drives, magnetic cassettes, flash memory cards or other types of memory cards, cartridges, or the like.

By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to include, without being limited, these and any other suitable types of memory.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated example aspects of the embodiments. In this regard, it will also be recognized that the embodiments include a system as well as a computer-readable medium having computer-executable instructions for performing the acts and/or events of the various methods.

Computing devices typically include a variety of media, which can include computer-readable storage media and/or communications media, which two terms are used herein differently from one another as follows. Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, solid state drive (SSD) or other solid-state storage technology, compact disk read only memory (CD ROM), digital versatile disk (DVD), Blu-ray disc or other optical disk storage, magnetic cassettes, magnetic tape, magnetic disk storage or other magnetic storage devices or other tangible and/or non-transitory media which can be used to store desired information.

In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se. Computer-readable storage media can be accessed by one or more local or remote computing devices, e.g., via access requests, queries or other data retrieval protocols, for a variety of operations with respect to the information stored by the medium.

On the other hand, communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communications media include wired media, such as a wired network or direct-wired connection, and wireless media such as acoustic, RF, infrared and other wireless media

Further, terms like “user equipment,” “user device,” “mobile device,” “mobile,” station,” “access terminal,” “terminal,” “handset,” and similar terminology, generally refer to a wireless device utilized by a subscriber or user of a wireless communication network or service to receive or convey data, control, voice, video, sound, gaming, or substantially any data-stream or signaling-stream. The foregoing terms are utilized interchangeably in the subject specification and related drawings. Likewise, the terms “access point,” “node B,” “base station,” “evolved Node B,” “cell,” “cell site,” and the like, can be utilized interchangeably in the subject application, and refer to a wireless network component or appliance that serves and receives data, control, voice, video, sound, gaming, or substantially any data-stream or signaling-stream from a set of subscriber stations. Data and signaling streams can be packetized or frame-based flows. It is noted that in the subject specification and drawings, context or explicit distinction provides differentiation with respect to access points or base stations that serve and receive data from a mobile device in an outdoor environment, and access points or base stations that operate in a confined, primarily indoor environment overlaid in an outdoor coverage area. Data and signaling streams can be packetized or frame-based flows.

Furthermore, the terms “user,” “subscriber,” “customer,” “consumer,” and the like are employed interchangeably throughout the subject specification, unless context warrants particular distinction(s) among the terms. It should be appreciated that such terms can refer to human entities, associated devices, or automated components supported through artificial intelligence (e.g., a capacity to make inference based on complex mathematical formalisms) which can provide simulated vision, sound recognition and so forth. In addition, the terms “wireless network” and “network” are used interchangeable in the subject application, when context wherein the term is utilized warrants distinction for clarity purposes such distinction is made explicit.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

In addition, while a particular feature may have been disclosed with respect to only one of several implementations, such feature may be combined with one or more other features of the other implementations as may be desired and advantageous for any given or particular application. Furthermore, to the extent that the terms “includes” and “including” and variants thereof are used in either the detailed description or the claims, these terms are intended to be inclusive in a manner similar to the term “comprising.”

The above descriptions of various embodiments of the subject disclosure and corresponding figures and what is described in the Abstract, are described herein for illustrative purposes, and are not intended to be exhaustive or to limit the disclosed embodiments to the precise forms disclosed. It is to be understood that one of ordinary skill in the art may recognize that other embodiments having modifications, permutations, combinations, and additions can be implemented for performing the same, similar, alternative, or substitute functions of the disclosed subject matter, and are therefore considered within the scope of this disclosure. Therefore, the disclosed subject matter should not be limited to any single embodiment described herein, but rather should be construed in breadth and scope in accordance with the claims below.

What is claimed is:

1. A method, comprising:
in an integrated access and backhaul network in which a child node has multiple parent nodes, aligning, via respective processors of the multiple parent nodes, respective independent distributed unit frame structure configurations of the multiple parent nodes; and
communicating the respective independent parent node distributed unit frame structure configurations to the child node for establishing a child node mobile termination function configuration and a child node distributed unit function configuration.

2. The method of claim 1, wherein the multiple parent nodes comprise a first parent node and a second parent node, wherein the child node establishes a first child distributed unit function configuration and a first child mobile termination function configuration corresponding to the first parent node distributed unit frame structure configuration, and wherein the child node establishes a second child distributed unit function configuration and a second child mobile termination function configuration corresponding to the second parent node distributed unit frame structure configuration.

3. The method of claim 1, wherein the child node supports full duplex or simultaneous operation on at least one of the backhaul links or frequency carriers, and wherein the child node receives or transmits on respective backhaul links to the multiple parent nodes independent of the respective independent distributed unit frame structure configurations of the multiple parent nodes.

4. The method of claim 1, wherein the child node receives or transmits on respective backhaul links to the multiple parent nodes based on which parent is transmitting.

5. The method of claim 1, wherein aligning the respective frame structure configurations is repeatedly performed.

6. The method of claim 1, wherein aligning the respective frame structure configurations is performed on a per-slot basis.

7. The method of claim 1, wherein aligning the respective frame structure configurations is performed for a group of slots.

8. The method of claim 1, wherein aligning the respective frame structure configurations is performed as a dynamic frame structure coordination that alternates with a semi-static frame structure coordination.

9. The method of claim 1, wherein the respective independent parent nodes comprise a first patent node and a second parent node, wherein the respective independent parent node distributed unit frame structure configurations comprise soft resources, wherein the first parent node determines utilization of the soft resources based on measurements corresponding to at least one of: the second parent node or the child node, and wherein the second parent node determines utilization of the soft resources based on measurements corresponding to at least one of: the first parent node or the child node.

10. The method of claim 1, wherein the respective independent parent nodes comprise a first patent node and a second parent node, wherein the respective independent parent node distributed unit frame structure configurations comprise soft resources, and wherein the first parent node and the second parent node communicate via messaging to determine utilization of the soft resources.

11. A system, comprising:
a processor; and
a memory that stores executable instructions that, when executed by the processor, facilitate performance of operations, the operations comprising:
determining, by a child node device comprising a processor, in an integrated access and backhaul network in which the child node has multiple parent nodes, which parent node is transmitting in a slot, and based on which parent node is transmitting in the slot;
selecting a first coordination configuration for child node user equipment function communications in the slot, or
selecting a second coordination configuration for child node distributed unit function communications in the slot.

12. The system of claim 11, wherein the determining which parent node is transmitting in the slot comprises obtaining respective parent node distributed unit coordination configurations for the multiple parent nodes.

13. The system of claim 12, wherein the multiple parent nodes comprise a first parent node and a second parent node, wherein the obtaining the respective parent node distributed unit coordination configurations for the multiple parent nodes comprises obtaining a first parent node distributed unit frame structure configuration corresponding to the first parent node, and obtaining a second parent node distributed unit frame structure configuration corresponding to the second parent node, and wherein the operations further comprise establishing the first coordination configuration and the second coordination configuration based on the first parent node distributed unit frame structure configuration and the second parent node distributed unit frame structure configuration.

14. The system of claim 11, wherein the child node supports half duplex operation, and further comprising aligning and coordinating uplink and downlink communications from the multiple parent nodes with the child node.

15. The system of claim 11, wherein the child node supports full duplex or simultaneous operation on one or more backhaul links or frequency carriers, and wherein the child node is able to receive or transmit on respective backhaul links to multiple parent nodes independent of respective configurations of the multiple parent nodes.

16. A non-transitory machine-readable storage medium, comprising executable instructions that, when executed by a processor, facilitate performance of operations, the operations comprising:
coordinating resource usage, by an integrated access and backhaul node device that acts as a first parent node to a child node, with a second parent node to the child node, the resource usage corresponding to a first coordinated configuration of the first parent node and a second coordinated configuration of the second parent node; and
providing information representing the first coordinated configuration and the second coordinated configuration to the child node for use in scheduling child node communications with the first parent node and the second parent node.

17. The non-transitory machine-readable storage medium of claim 16, wherein, following coordinating the resource usage and providing the information representing the first coordinated configuration and the second coordinated configuration to the child node, another cycle of the coordinating and the providing begins.

18. The non-transitory machine-readable storage medium of claim 16, wherein coordinating the resource usage and providing the information representing the first coordinated configuration and the second coordinated configuration to the child node are performed on a per-slot basis.

19. The non-transitory machine-readable storage medium of claim 16, wherein coordinating the resource usage and providing the information representing the first coordinated configuration and the second coordinated configuration to the child node are performed for a plurality of slots.

20. The non-transitory machine-readable storage medium of claim 16, wherein coordinating the resource usage and providing the information representing the first coordinated configuration and the second coordinated configuration to the child node are performed and used alternately with semi-static frame structure coordination.
